(19) United States
(12) Patent Application Publication
(10) Pub. No.: US 2019/0385628 A1
(43) Pub. Date: Dec. 19, 2019

(54) VOICE CONVERSION / VOICE IDENTITY CONVERSION DEVICE, VOICE CONVERSION / VOICE IDENTITY CONVERSION METHOD AND PROGRAM

(71) Applicant: THE UNIVERSITY OF ELECTRO-COMMUNICATIONS, Chofu-shi, Tokyo (JP)

(72) Inventor: Toru NAKASHIKA, Chofu-shi (JP)

(73) Assignee: THE UNIVERSITY OF ELECTRO-COMMUNICATIONS, Chofu-shi, Tokyo (JP)

(21) Appl. No.: 16/489,513

(22) PCT Filed: Feb. 27, 2018
(86) PCT No.: PCT/JP2018/007268

§ 371 Date: Aug. 28, 2019

(30) Foreign Application Priority Data
Feb. 28, 2017 (JP) 2017-036109

(51) Int. Cl. G10L 21/013; G10L 25/03; G06N 20/00

(52) U.S. Cl. CPC G10L 21/013; G10L 2021/0135; G06N 20/00; G10L 25/03

(57) ABSTRACT

This voice conversion/voice identity conversion device is provided with a parameter learning unit, a parameter storage unit and a voice conversion/voice identity conversion processing unit. The parameter learning unit prepares a probability model by means of a restricted Boltzmann machine assuming that there is a connection weight between a visible element representing input data and a hidden element representing potential information. The parameter learning unit defines, as a probability model, a plurality of speaker clusters having specific adaptive matrices, and determines parameters for each speaker by estimating weights for the plurality of speaker clusters. The parameter storage unit stores the parameters. A voice conversion/voice identity conversion processing unit performs voice conversion/voice identity conversion processing of acoustic information based on the voice of a source speaker based on the parameters stored in the parameter storage unit and speaker information of a target speaker.

### TECHNICAL FIELD

The present invention relates to a voice conversion/voice identity conversion device, voice conversion/voice identity conversion method and program that enable voice conversion/voice identity conversion for a given speaker.

### BACKGROUND ART

In the related art, in the field of voice conversion/voice identity conversion, which is a technique for converting only information related to speaker properties into that of a target speaker while storing phonological information of a source speaker's voice, parallel voice conversion/voice identity conversion using parallel data, which is a pair of voices based on the same speech content of the source speaker and the target speaker during model learning, has been mainstream.

As parallel voice conversion/voice identity conversion, various statistical approaches have been proposed such as a method based on GMM (Gaussian Mixture Model), a method based on NMF (Non-negative Matrix Factrization), and a method based on DNN (Deep Neural Network) (Patent Literature 1). In parallel voice conversion/voice identity conversion, although relatively high accuracy can be obtained owing to a parallel restriction, there is a problem that convenience is lost because it is necessary to match the speech contents of the source speaker and the target speaker as learning data.

On the other hand, non-parallel voice conversion/voice identity conversion that does not use the above-mentioned parallel data at the time of the model learning attracts attention. While the non-parallel voice conversion/voice identity conversion is inferior in accuracy to parallel voice conversion/voice identity conversion, it is highly convenient and practicable because learning can be performed using any speech. Non Patent Literature 1 describes a technique to enable the voice conversion/voice identity conversion using a speaker included in the learning data as the source speaker or a target speaker by learning individual parameters in advance using the voice of the source speaker and the voice of the target speaker.

### CITATION LIST

### Patent Literature

Patent Literature 1: JP 2008-58696 A

### Non Patent Literature

Non Patent Literature 1: T. Nakashika, T. Takiguchi, and Y. Ariki: “Parallel-Data-Free, Many-To-Many Voice Conversion Using an Adaptive Restricted Boltzmann Machine,” Proceedings of Machine Learning in Spoken Language Processing (MLSLP) 2015, 6 pages, 2015.

### SUMMARY OF INVENTION

### Technical Problem

The technique described in Non Patent Literature 1 is voice conversion/voice identity conversion based on adaptive RBM (ARBM) to which Restricted Boltzmann Machine (hereinafter referred to as RBM) is applied as a statistical non-parallel voice conversion/voice identity conversion approach. In this approach, speaker-specific adaptive matrices are estimated automatically from voice data by a plurality of speakers, and simultaneously, a projection matrix to the potential features which do not depend on the speaker (hereinafter referred to as “latent phonemes” or simply as “phonemes”) is estimated from the acoustic feature quantity (mel cepstrum). As a result, a voice close to the target speaker can be obtained by calculating the acoustic feature quantity using the latent phonemes calculated from the voice of the source speaker and the adaptive matrix of the source speaker and the adaptive matrix of the target speaker.

Once the projection matrix for obtaining the latent phonemes is estimated by learning, conversion can by performed by estimating only the respective adaptive matrices for new source speakers and target speakers (this step is referred to as adaptation). However, since the speaker-specific adaptive matrix includes squared parameters of the acoustic feature quantity, the number of parameters increases as the number of dimensions of the acoustic feature quantity and the number of speakers increase, and the learning cost increases. And the number of data required at the time of adaptation increases, and the problem that the conversion on the spot of the speaker who has not learned in advance becomes difficult may occur. Moreover, in the scene in which the voice conversion/voice identity conversion is utilized, the case where voice is recorded on the spot and immediate conversion is wanted is considered, but the immediate conversion was difficult in the related art.

In view of the foregoing, it is an object of the present invention to provide a voice conversion/voice identity conversion device, voice conversion/voice identity conversion method, and program capable of easily performing voice conversion/voice identity conversion with a small number of data for each speaker's speech.

### Solution to Problem

In order to solve the above problems, the voice conversion/voice identity conversion device of the present invention is a voice conversion/voice identity conversion device that converts voice of a source speaker into voice of a target speaker, and includes a parameter learning unit, a parameter storage unit, and a voice conversion/voice identity conversion processing unit.

The parameter learning unit determines parameters for voice conversion/voice identity conversion from acoustic information based on voice for learning and speaker information corresponding to the speaker information.

The parameter storage unit stores the parameters determined by the parameter learning unit.

The voice conversion/voice identity conversion processing unit performs voice conversion/voice identity conversion processing of acoustic information based on the voice of the source speaker based on the parameters stored in the parameter storage unit and the speaker information of the target speaker.

Here, the parameter learning unit uses the acoustic information based on the voice, the speaker information corresponding to the acoustic information, and the phonological information representing the phoneme in the voice as variables, so that a probability model representing the relationship in connection energy among the acoustic information, the speaker information and the phonological information by parameters is obtained, and a plurality of speaker clusters having specific adaptive matrices are defined as the probability model.

Further, the voice conversion/voice identity conversion method of the present invention is a method for converting voice of a source speaker into voice of a target speaker and includes a parameter learning step and a voice conversion/voice identity conversion processing step.

The parameter learning step uses the acoustic information based on the voice, the speaker information corresponding to the acoustic information, and the phonological information representing the phoneme in the voice as variables, so that the probability model representing the relationship in connection energy among the acoustic information, the speaker information and the phonological information by parameters is prepared. Then, a plurality of speaker clusters having specific adaptive matrices are defined as the probability model, weights for the plurality of speaker clusters are estimated for each speaker, and parameters for the voice for learning are determined.

In the voice conversion/voice identity conversion processing step, voice conversion/voice identity conversion processing is performed on the acoustic information based on the voice of the source speaker based on parameters obtained in the parameter learning step or parameters after adaptation of the parameters into the voice of the source speaker, and the speaker information of the target speaker.

A program according to the present invention causes a computer to execute the parameter learning step and the voice conversion/voice identity conversion processing step of the voice conversion/voice identity conversion method described above.

According to the present invention, since the target speaker can be set by the speaker clusters, the voice quality of the source speaker's voice can be converted into the target speaker voice with a significantly small number of data compared to the related art.

### BRIEF DESCRIPTION OF DRAWINGS

FIG. 1 is a block diagram illustrating a configuration example (Example 1) of a voice conversion/voice identity conversion device according to an exemplary embodiment of the present invention.

FIG. 2 is a block diagram illustrating a configuration example (Example 2) of the voice conversion/voice identity conversion device according to an exemplary embodiment of the present invention.

FIG. 3 is a block diagram illustrating an example of a hardware configuration of the voice conversion/voice identity conversion device.

FIG. 4 is an explanatory drawing schematically illustrating a probability model of the related art.

FIG. 5 is an explanatory drawing schematically illustrating a probability model provided in a parameter estimating part of the voice conversion/voice identity conversion device.

FIG. 6 is a flowchart illustrating the flow of entire processing according to an exemplary embodiment of the present invention.

FIG. 7 is a flowchart illustrating a detailed example of learning in Step S3 in FIG. 6.

FIG. 8 is a flowchart illustrating a detailed example of adaptation of Step S4 in FIG. 6.

FIG. 9 is a flowchart illustrating a detailed example of voice conversion/voice identity conversion in Step S8 of FIG. 6.

FIG. 10 is an explanatory drawing illustrating an example of cluster weight distribution according to an embodiment of the present invention.

FIG. 11 is an explanatory drawing illustrating another example of the probability model provided in the parameter estimating part of the voice conversion/voice identity conversion device.

### DESCRIPTION OF EMBODIMENTS

Hereinafter, a preferred exemplary embodiment of the present invention will be described.

### [1. Configuration]

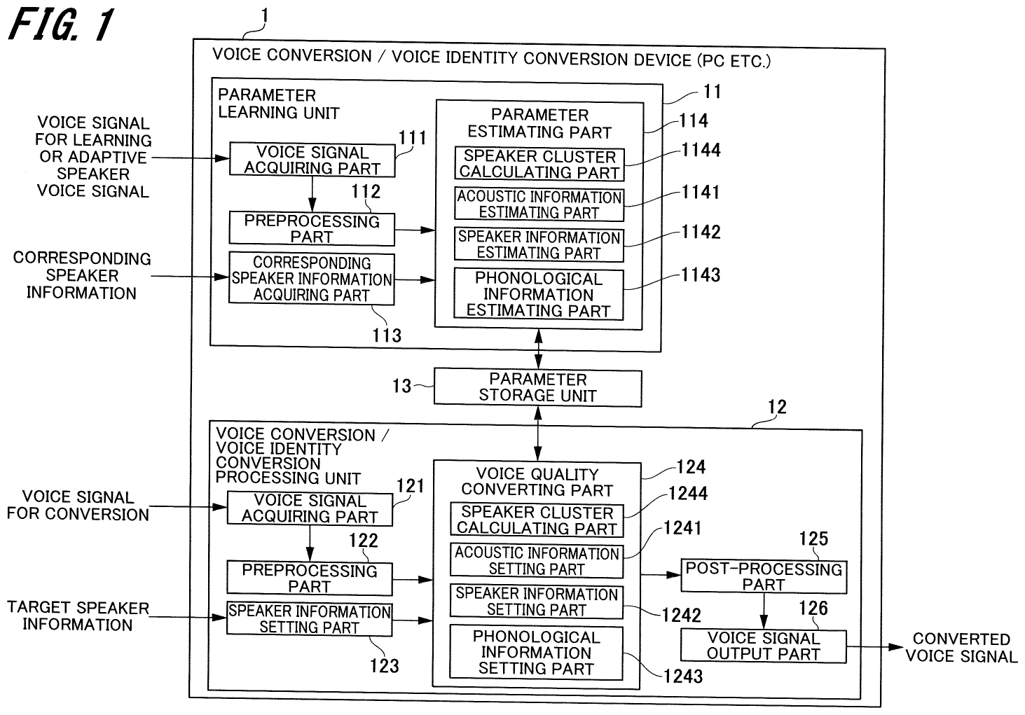

FIG. 1 is a diagram illustrating a configuration example (Example 1) of a voice conversion/voice identity conversion device according to an exemplary embodiment of the present invention. The voice conversion/voice identity conversion device 1 configured by a PC or the like in FIG. 1 performs learning in advance based on information on a speaker corresponding to a voice signal for learning and information on a speaker corresponding to the voice signal for learning (corresponding speaker information), whereby a voice signal for conversion (adaptive speaker voice signal) from a given speaker is converted into a voice quality of a target speaker, and outputs the converted signal as a converted voice signal.

The voice signal for learning may be a voice signal based on voice data recorded in advance, or may be a voice (sound wave) of a speaker directly converted by a microphone or the like into an electrical signal. The corresponding speaker information may be any information as long as it can distinguish whether a voice signal for learning and another voice signal for learning are voice signals from the same speaker or voice signals from different speakers.

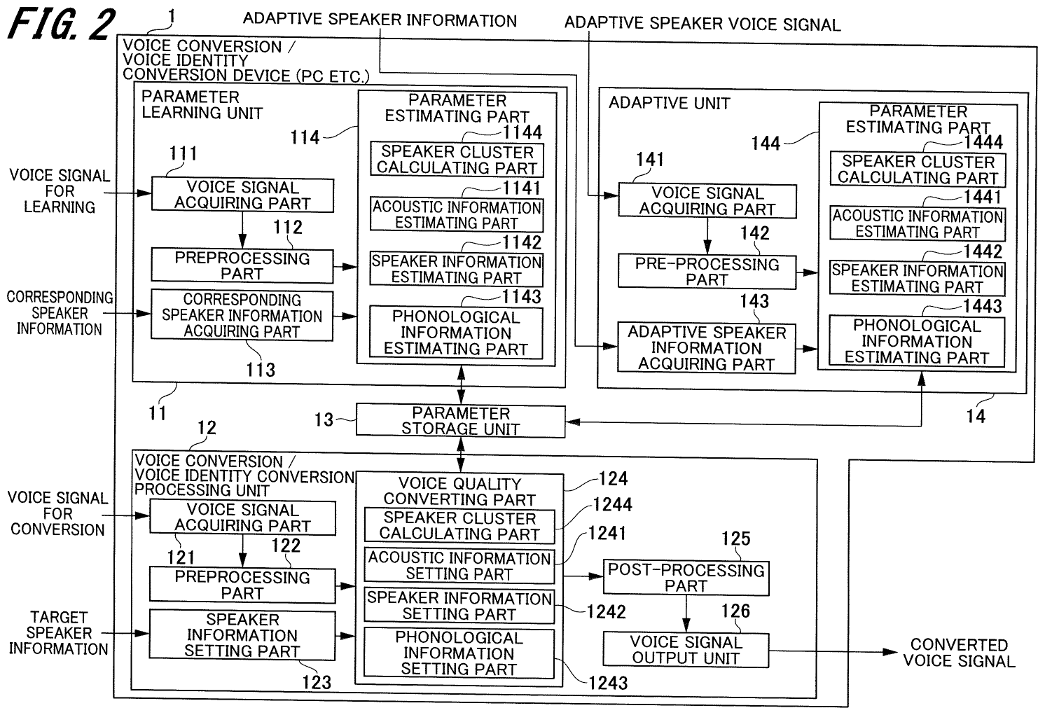

The voice conversion/voice identity conversion device 1 includes a parameter learning unit 11, a voice conversion/voice identity conversion processing unit 12, and a parameter storage unit 13. The parameter learning unit 11 determines parameters for voice conversion/voice identity conversion by learning processing based on the voice signal for learning and the corresponding speaker information. The parameters determined by the parameter learning unit 11 are stored in the parameter storage unit 13. The parameters stored in the parameter storage unit 13 are converted by the parameter learning unit 11 into parameters after adaptation of the source speaker by adaptive processing. The voice conversion/voice identity conversion processing unit 12, after the determination of the parameters by the above-described learning processing and the adaptive processing, converts the voice quality of the voice signal for conversion into the voice quality of the target speaker based on the determined parameters and information on the target speaker (target speaker information), and outputs as the converted voice signal. The parameter learning unit 11 performing both the learning processing and the adaptive processing is an example only, and as illustrated in FIG. 2 described later, the adaptive unit 14 may be provided separately from the parameter learning unit 11.

The parameter learning unit 11 includes a voice signal acquiring part 111, a preprocessing part 112, a speaker information acquiring part 113, and a parameter estimating part 114. The voice signal acquiring part 111 is connected to the preprocessing part 112, and the preprocessing part 112 and the speaker information acquiring part 113 are each connected to the parameter estimating part 114.

The voice signal acquiring part 111 is configured to acquire a voice signal for learning from a connected external device, and for example, a learning voice signal is acquired based on a user's operation via an input unit, not illustrated, such as a mouse or a keyboard. Further, the voice signal acquiring part 111 may capture the speech of the speaker in real time from a connected microphone, not illustrated. In the following description, the parameter learning unit 11 acquires the voice signal for learning to obtain the parameters. However, even in the adaptive processing by the parameter learning unit 11 acquiring the parameters adapted to the adaptive speaker voice signal, each of the processing parts performs the same processing. Although the details of the adaptive processing will be described later, at the time of adaptive processing, adaptation processing using the parameters stored in the parameter storage unit 13 during the learning processing as parameters adapted to the adaptive speaker voice signal is performed.

The preprocessing part 112 cuts out the voice signal for learning acquired by the voice signal acquiring part 111 every unit time (hereinafter, referred to as a frame), and after the spectral feature quantity of the voice signal for each frame such as Mel-Frequency Cepstrum Coefficients (MFCC) or a mel cepstrum feature quantity are calculated, performs normalization, so that acoustic information for learning is generated.

The corresponding speaker information acquiring part 113 acquires corresponding speaker information associated with the acquisition of the voice signal for learning by the voice signal acquiring part 111. The corresponding speaker information may be any information as long as it can distinguish a speaker of a certain voice signal for learning from a speaker of another voice signal for learning, and is acquired, for example, by the user's input via an input unit, not illustrated. Also, if it is clear that the speakers are different for each of the plurality of voice signals for learning, the corresponding speaker information acquiring part 113 may automatically assign the corresponding speaker information at the time of acquisition of the voice signals for learning. For example, assuming that the parameter learning unit 11 learns the speeches of 10 persons, the corresponding speaker information acquiring part 113 acquires information for distinguishing a voice signal of the speech of one out of 10 speakers from the voice signal for learning being input to the voice signal acquiring part 111 (corresponding speaker information) automatically or by input from the user. In addition, the number of persons set to 10 here for performing speech learning is an example only. The parameter learning unit 11 can perform learning if at least voices of two persons are input, but more accurate learning can be performed if the number of persons is larger.

The parameter estimating part 114 has an adaptive RBM (ARBM) probability model to which an RBM (Restricted Boltzmann Machine) configured by an acoustic information estimating part 1141, a speaker information estimating part 1142, and a phonological information estimating part 1143 is applied, and estimates parameters based on the voice signal for learning. The parameters estimated by the learning processing by the parameter estimating part 114 are stored in the parameter storage unit 13. The parameters obtained by this learning processing is read out from the parameter storage unit 13 to the parameter learning unit 11 when the voice signal of the adaptive speaker is input to the parameter learning unit 11, and is used as parameters adapted to the voice signal of the adapted speaker at that time.

The probability model of the present exemplary embodiment as applied when the parameter estimating part 114 estimates parameters includes information of a plurality of speaker clusters obtained from the speaker's characteristics in addition to the acoustic information, the speaker information, and the phonological information possessed by each of the estimating parts 1141, 1142, and 1143. In other words, the parameter estimating part 114 has a speaker cluster calculating part 1144 that calculates this speaker cluster. Furthermore, the probability model of the present exemplary embodiment has parameters representing the relationship in connection energy among the respective pieces of information. In the following description, the probability model of the present exemplary embodiment is referred to as speaker cluster adaptive RBM. Details of the speaker cluster adaptive RBM will be described later.

The acoustic information estimating part 1141 acquires acoustic information using the phonological information, the speaker information, and various parameters. Here, the acoustic information means an acoustic vector (such as a spectral feature quantity or a cepstral feature quantity) of the voice signal of each speaker.

The speaker information estimating part 1142 estimates speaker information using acoustic information, phonological information, and various parameters. Here, the speaker information is information for specifying a speaker, and is acoustic vector information possessed by the voice of each speaker. In other words, this speaker information (speaker vector) means a vector for identifying the speaker of the voice signal, which is common to all voice signals of the same speaker and is different from each other for voice signals of different speakers.

The phonological information estimating part 1143 estimates phonological information based on acoustic information, speaker information, and various parameters. Here, the phonological information is information that is common to all the speakers who perform learning among the information included in the acoustic information. For example, when an input voice signal for learning is a signal of voice saying “hello!”, the phonological information obtained from this voice signal corresponds to information on words output as “hello!” However, even if the phonological information in the present exemplary embodiment is information corresponding to a word, it is not so-called text information and is phonological information which is not limited to the type of language, and is a vector that represents information common to any language spoken by the speaker and is potentially included in the voice signal but other than the speaker information.

The speaker cluster calculating part 1144 calculates a cluster corresponding to speaker information obtained from the voice signal for learning being input. In other words, the speaker cluster adaptive RBM provided in the parameter estimating part 114 has a plurality of clusters indicating speaker information, and the speaker cluster calculating part 1144 calculates the cluster corresponding to the speaker information obtained from the voice signal for learning being input.

In addition, the speaker cluster adaptive RBM provided in the parameter estimating part 114 not only has acoustic information, speaker information, phonological information, and information of speaker clusters, but also represents the relationship in connection energy among the respective pieces of information by the parameters.

The voice conversion/voice identity conversion processing unit 12 includes a voice signal acquiring part 121, a preprocessing part 122, a speaker information setting part 123, a voice quality converting part 124, a post-processing part 125, and a voice signal output part 126. The voice signal input 121, the preprocessing part 122, the voice quality converting part 124, the post-processing part 125, and the voice signal output part 126 are sequentially connected, and the parameter estimating part 114 of the parameter learning unit 11 is connected to the voice quality converting part 124.

The voice signal acquiring part 121 acquires a voice signal for conversion, and the preprocessing part 122 generates the acoustic information for conversion based on the voice signal for conversion. In the present exemplary embodiment, the voice signal for conversion acquired by the voice signal acquiring part 121 may be a voice signal for conversion by a given speaker.

The voice signal acquiring part 121 and the preprocessing part 122 are the same as the configurations of the voice signal acquiring part 111 and the preprocessing part 112 of the parameter learning unit 11 described above, and they may be shared without being separately installed.

A speaker information setting part 123 sets a target speaker which is a voice conversion/voice identity conversion destination and outputs target speaker information. Here, the target speaker set by the speaker information setting part 123 is selected from the speakers whose speaker information has been acquired by the parameter estimating part 114 of the parameter learning unit 11 through the learning processing performed in advance. The speaker information setting part 123 may be configured, for example, to select one target speaker by a user via an input unit, not illustrated, from a plurality of target speaker options (such as a list of speakers for which the parameter estimating part 114 has applied the learning processing in advance) displayed on a display, not illustrated, and may be configured to be able to confirm the voice of the target speaker via a speaker, not illustrated.

The voice quality converting part 124 performs voice conversion/voice identity conversion on the acoustic information for conversion based on the target speaker information, and outputs the converted acoustic information. The voice quality converting part 124 includes an acoustic information setting part 1241, a speaker information setting part 1242, a phonological information setting part 1243, and a speaker cluster calculating part 1244. The acoustic information setting part 1241, the speaker information setting part 1242, the phonological information setting part 1243, and the speaker cluster calculating part 1244 have equivalent functions to those of the acoustic information estimating part 1141, the speaker information estimating part 1142, the phonological information estimating part 1143, and the speaker cluster calculating part 1144 possessed by the probability model of the speaker cluster adaptive RBM in the above-described parameter estimating part 114.

In other words, although the acoustic information, the speaker information and the phonological information are set in the acoustic information setting part 1241, the speaker information setting part 1242 and the phonological information setting part 1243, respectively, the phonological information set in the phonological information setting part 1243 is information obtained based on the acoustic information supplied from the preprocessing part 122. On the other hand, the speaker information set in the speaker information setting part 1242 is speaker information (speaker vector) about the target speaker acquired from the estimation result in the speaker information estimating part 1142 in the parameter learning unit 11. The acoustic information set in the acoustic information setting part 1241 can be obtained from the speaker information and the phonological information set in the speaker information setting part 1242 and the phonological information setting part 1243 and various parameters. The speaker cluster calculating part 1244 calculates speaker cluster information of the target speaker.

Although FIG. 1 illustrates the configuration in which the voice quality converting part 124 is provided, a configuration in which the parameter estimating part 114 performs voice conversion/voice identity conversion processing by fixing various parameters of the parameter estimating part 114 without separately installing the voice quality converting part 124.

The post-processing part 125 performs an inverse normalization process on the converted acoustic information obtained by the voice quality converting part 124, and further performs an inverse FFT processing to recovers the spectrum information into a voice signal for each frame and combines the recovered acoustic information to generate a converted voice signal.

The voice signal output part 126 outputs the converted voice signal to a connected external device. Examples of the external device to be connected include a speaker.

FIG. 2 is a diagram illustrating another configuration example (Example 2) of a voice conversion/voice identity conversion device according to an exemplary embodiment of the present invention.

The voice conversion/voice identity conversion device 1 illustrated in FIG. 2 differs from the voice conversion/voice identity conversion device 1 illustrated in FIG. 1 in that the adaptive unit 14 for performing the adaptive processing of the parameters by the adaptive speaker voice signal. In other words, in the voice conversion/voice identity conversion device 1 illustrated in FIG. 1, the parameter learning unit 11 performs both the learning processing and the adaptation process, whereas in the voice conversion/voice identity conversion device 1 illustrated in FIG. 2, it is different in that the adaptive unit 14 performs the adaptive processing.

The adaptive unit 14 includes a voice signal acquiring part 141, a preprocessing part 142, an adaptive speaker information acquiring part 143, and a parameter estimating part 144. The voice signal acquiring part 141 acquires an adaptive speaker voice signal, and outputs the acquired voice signal to the preprocessing part 142. The preprocessing part 142 performs preprocessing of the voice signal to obtain acoustic information for adaptation, and supplies the obtained adaptive acoustic information to the parameter estimating part 144. The adaptive speaker information acquiring part 143 acquires speaker information on the adaptive speaker, and supplies the acquired adaptive speaker information to the parameter estimating part 144.

The parameter estimating part 144 includes an acoustic information estimating part 1441, a speaker information estimating part 1442, a phonological information estimating part 1443 and a speaker cluster calculating part 1444, and includes acoustic information, speaker information, phonological information, and speaker clusters.

The parameters after application obtained by the adaptive unit 14 are stored in the parameter storage unit 13 and then supplied to the voice conversion/voice identity conversion processing unit 12. Alternatively, the applied parameters obtained by the adaptive unit 14 may be supplied directly to the voice conversion/voice identity conversion processing unit 12.

The other parts of the voice conversion/voice identity conversion device 1 illustrated in FIG. 2 are configured in the same manner as the voice conversion/voice identity conversion device 1 illustrated in FIG. 1.

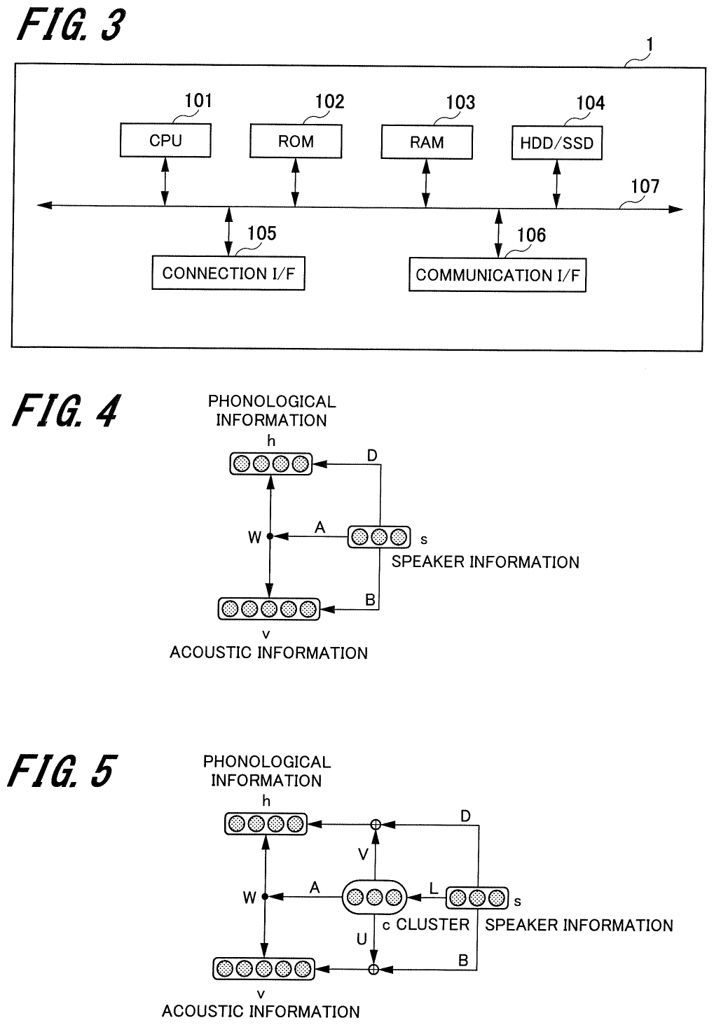

FIG. 3 is a diagram illustrating an example of the hardware configuration of the voice conversion/voice identity conversion device 1. Here, an example in which the voice conversion/voice identity conversion device 1 is configured by a computer (PC) is illustrated.

As illustrated in FIG. 3, the voice conversion/voice identity conversion device 1 includes a central control unit (CPU) 101, a read only memory (ROM) 102, a random access memory (RAM) 103, a Hard Disk Drive (HDD)/Solid State Drive (SSD) 104, a connection I/F (Interface) 105, and a communication I/F 106 connected mutually via a bus 107. The CPU 101 centrally controls an operation of the voice conversion/voice identity conversion device 1 by executing a program stored in the ROM 102 or the HDD/SSD 104 with the RAM 103 as a work area. The connection I/F 105 is an interface with a device connected to the voice conversion/voice identity conversion device 1. The communication I/F is an interface for communicating with another information processing device via a network.

Input/output and setting of the voice signal for learning, the voice signal for conversion, and the converted voice signal are performed via the connection I/F 105 or the communication I/F 106. The storage of parameters in the parameter storage unit 13 is performed by the RAM 103 or the HDD/SSD 104. The function of the voice conversion/voice identity conversion device 1 described in FIG. 1 is realized by the CPU 101 executing a predetermined program. The program may be acquired via a recording medium, may be acquired via a network, or may be used by incorporating in the ROM. Instead of a combination of general computers and programs, a hardware configuration for realizing the configuration of the voice conversion/voice identity conversion device 1 by combining logic circuits such as application specific integrated circuits (ASICs) and field programmable gate arrays (FPGAs) is also applicable.

### [2. Definition of Speaker Cluster Adaptive RBM]

Next, a speaker cluster adaptive RBM which is a probability model possessed by a parameter estimating part 113 and an encoding part 123 will be described.

First, before describing a speaker cluster adaptive RBM applied to the present invention, an adaptive RBM which is a probability model already proposed will be described.

FIG. 4 is a diagram schematically illustrating a graph structure of the adaptive RBM.

The probability model of the adaptive RBM includes acoustic information v, speaker information s and phonological information h, as well as parameters representing the relationship in connection energy among the respective pieces of information. Here, assuming that two-way connection weight WER^{I×J} depending on the speaker feature quantity s=[s1, . . . , sR]∈{0,1}R, Σrsr=1 exists between a feature quantity v=[v₁, . . . , v_{I}]∈R^{I} of sound (mel cepstrum) information and a feature quantity h=[h₁, . . . , h_{J}]∈{0,1}^{J}, Σⱼhⱼ=1 of phonological information, the probability model of the adaptive RBM is represented by the conditional probability density function represented by the following [Formula 1] to [Formula 3].

$$\begin{matrix}p ( v , h \vert s ) = \frac{1}{Z} {e}^{- E ( v , h \vert s )} & [ Formula 1 ] \\ E ( v , h \vert s ) = \frac{1}{2} {‖ \frac{v - \overline{b}}{σ} ‖}_{2}^{2} - {\tilde{d}}^{⊤} h - {( \frac{v}{{σ}^{2}} )}^{⊤} \tilde{W} h & [ Formula 2 ] \\ Z = {\sum }_{v , h} {e}^{- E ( v , h \vert s )} & [ Formula 3 ]\end{matrix}$$

where, σ∈R^{I} is a parameter representing the deviation of the acoustic feature quantity, and b∈R^{I} and d∈R^{J} respectively indicate biases of the acoustic feature quantity and the phonological feature quantity bias depending on the speaker feature quantity s. “˜” added above the symbol in the formula indicates that the corresponding information is information dependent on the speaker. In the specification, “˜” cannot be added above the symbol due to a restriction on the notation, so that it is illustrated in parentheses after the symbol, for example, as in W (˜). The same applies to other symbols illustrated above the symbols, such as “\hat{ }”.

Also, vinculum and the “⋅²” on the right-hand side of the [Formula 2] respectively indicate the division for each element and the square for each element. The speaker dependent terms W (˜), b (˜), d (˜) can be defined as in the following [Formula 4] to [Formula 6] using the speaker-independent parameters and the speaker-dependent parameters.

$$\begin{matrix}\tilde{W} {\sum }_{r} {A}_{r} {s}_{r} W = ∘ \frac{1}{3} sW & [ Formula 4 ] \\ \tilde{b} {\sum }_{r} {b}_{r} {s}_{r} = b + Bs & [ Formula 5 ] \\ \tilde{d} {\sum }_{r} {d}_{r} {s}_{r} = d + Ds & [ Formula 6 ]\end{matrix}$$

where, W∈R^{I×J}, b∈R^{I}, d∈R^{J} represent speaker-independent parameters, and Aᵣ∈R^{I×I}(A={Aᵣ}ᵣ₌₁^{R}), bᵣ∈R^{I}(B=[b₁, . . . , b_{R}]), dᵣ∈R^{J}(D=[d₁, . . . , d_{R}]) represent parameters depending on the speaker r. Further, oᵢ^{j} represents an inner product operation along the mode i of the left tensor and the mode j of the right tensor.

Here, the acoustic feature quantity is the mel cepstrum of clean voice, and the parameter variations due to the difference of the speaker are absorbed in speaker-dependent terms ([Formula 4], [Formula 5], [Formula 6], defined by the speaker feature quantity s. Therefore, the phonological feature quantity includes phonological information, which is an unobservable feature quantity in which only one of the speaker-independent elements is active.

As described above, although the acoustic feature quantity and the phonological feature quantity can be obtained by the adaptive RBM, in the adaptive RBM, the number of speaker-dependent parameters is proportional to (I²R). Since the square of the acoustic feature quantity (I²) is relatively large, the number of speakers increases, and the number of parameters to be estimated becomes enormous as the number of speakers increases, so that the cost for calculation increases. In addition, even when a certain speaker r is adapted, the number of parameters to be estimated is (I²+I+J), and there is a problem that a correspondingly large amount of data is required to avoid over-learning.

Here, in the present invention, speaker cluster adaptive RBM is applied to solve these problems.

FIG. 5 is a diagram schematically illustrating a graph structure of the speaker cluster adaptive RBM.

The probability model of the speaker cluster adaptive RBM includes speaker cluster c∈R^{K} in addition to the acoustic information v, the speaker information s, and the phonological information h, and the parameters representing the relationship in connection energy among the respective pieces of information. The speaker cluster c is expressed identically with the following [Formula 7].

c [symbol] Ls [Formula 7]

However, each column vector λr of L∈R^{K×R}=[λ¹ . . . λ^{R}] is a non-negative parameter representing the weight to each speaker cluster, and imposes a constraint of ∥λᵣ∥₁=1, ∀r.

In the adaptive RBM described above (FIG. 4), the adaptation matrix is prepared for each speaker, but in the speaker cluster adaptive RBM of the present invention, the adaptive matrix is prepared for each cluster. In addition, the biases of the acoustic feature quantities and the phonological feature quantities are expressed by addition of a speaker-independent term, a cluster-dependent term, and a speaker-dependent term. In other words, the speaker dependent terms W (˜), b (˜), d (˜) are defined as in the following [Formula 8] to [Formula 10].

\tilde{W} [symbol] Ao₃¹cW [Formula 8]

\tilde{b} [symbol] b+Uc+Bs [Formula 9]

\tilde{d} [symbol] d+Vc+Ds [Formula 10]

where, the bias parameter of the cluster-dependent term of the feature quantity of the acoustic information is U∈R^{I×K}, and the bias parameter of the cluster dependent term of the feature quantity of the phonological information is V∈R^{J×K}.

Comparing A={Ak}ₖ₌₁^{K} illustrated in [Formula 8] with A in [Formula 4] in the adaptive RBM described above, (I²R) parameters are included in the adaptive RBM, whereas the speaker cluster adaptive RBM has (I²K) parameters, which means that the number of parameters can be significantly reduced. For example, if R=58, I=32, and K=8, are set, the number of parameters is 59392 in the adaptive RBM described above, but 8192 in the speaker cluster adaptive RBM, which means that the number of parameters can be significantly reduced.

Further, the number of parameters per speaker is I²+I+J (=1072) (in the case of H=16) in the above-described adaptive RBM, whereas the number of the parameters may be K+I+J (=56) per speaker in the speaker cluster adaptive RBM. Therefore, according to the speaker cluster adaptive RBM, the number of parameters can be significantly reduced, and adaptation can be performed with a small amount of data.

Also in the speaker cluster adaptive RBM, the conditional probability p (v, h|s) is defined by [Formula 1] to [Formula 3] described above. At this time, conditional probabilities p (v|h, s) and p (h|v, s) are as represented by the following [Formula 11] and [Formula 12], respectively.

$$\begin{matrix}p ( v \vert h , s ) = 𝒩 ( v \vert \tilde{b} + \tilde{W} h , {σ}^{2} ) & [ Formula 11 ] \\ p ( h \vert v , s ) = ℬ ( h \vert f ( \tilde{d} + {\tilde{W}}^{⊤} \frac{v}{{σ}^{2}} ) ) & [ Formula 12 ]\end{matrix}$$

where, N (⋅) on the right side of [Formula 11] is a multivariate normal distribution independent of dimensions, B (⋅) on the right side of [Formula 12] is multidimensional Bernoulli distribution, and f (⋅) is softmax function for each element.

The phonological feature quantity h is known, and considering the average vector μᵣ of the acoustic feature quantity of a certain speaker r, the average vector is as illustrated in the following [Formula 13] from [Formula 11].

$${μ}_{r} = b + {b}_{r} + U {λ}_{r} + ∘ \frac{1}{3} {λ}_{r} W h = M {λ}_{r}^{′} + {b}_{r} \qquad [ Formula 13 ]$$

where, λᵣ′=[λᵣ^{T} 1]^{T} is an extension vector of λr, and each column vector of M=[μ₁, . . . , λ_{K+1}] is defined by [Formula 14].

$${μ}_{k} = \{ \begin{matrix}{u}_{k} + {A}_{k} W h & ( k = 1 , … , K ) \\ b & ( k = K + 1 )\end{matrix} \qquad [ Formula 14 ]$$

In the speaker cluster adaptive RBM according to an exemplary embodiment of the present invention, the speaker-dependent term bᵣ is present, and the speaker-independent average vector μₖ has a feature structured as in [Formula 14]. In addition, potential phonological feature quantity is defined as a positive random variable.

Also, in a speaker cluster adaptive RBM according to an exemplary embodiment of the present invention, speaker-independent parameters and speaker cluster weights can be estimated simultaneously. In other words, to maximize the log likelihood (Formula 15]) for voice data {vₙ|sₙ}ₙ₌₁^{N} of N frames by R speakers, all parameters Θ={W, U, V, A, L, B, D, b, d, σ} can be simultaneously updated and estimated using the stochastic gradient method. Here, the gradient of each parameter is omitted.

$$ℒ = log {\prod }_{n} p ( {v}_{n} \vert {s}_{n} ) = {\sum }_{n} log {\sum }_{n} p ( {v}_{n} , {h}_{n} \vert {s}_{n} ) \qquad [ Formula 15 ]$$

Although expected values for models that are difficult to calculate appear in each gradient, it can be efficiently approximated using the Contrastive Divergence method (CD method) as in a normal RBM probability model.

Also, in order to satisfy the non-negative condition of cluster weights, parameter update is performed with zᵣ, replacing λᵣ=e^{zr}. The cluster weights are regularized to satisfy ∥λᵣ∥₁=1 after parameter updating.

Furthermore, if model learning is performed, it is considered that the formation of phonological feature quantity and clusters is completed, and only Θ_{r′}={λ_{r′}, b_{r′}, d_{r′}} is updated and estimated for a new speaker r′, and other parameters are fixed.

When applying this speaker cluster adaptive RBM to voice conversion/voice identity conversion, the acoustic feature quantity v⁽ⁱ⁾ and the speaker feature quantity s⁽ⁱ⁾ of the voice of a certain source speaker, and the speaker feature quantity s^{(o)} of the target speaker are given, the acoustic feature quantity v^{(o)} with the highest probability is formulated as the acoustic feature quantity of the target speaker as illustrated in [Formula 16].

$$\begin{matrix}\hat{v} {argmax}_{v} p ( v \vert , {v}^{( i )} , {s}^{( i )} , {s}^{( o )} ) \\ ≃ {argmax}_{v} p ( v \vert \hat{h} , {s}^{( o )} ) \\ = b + {Bs}^{( o )} + {ULs}^{( o )} + ∘ \frac{1}{3} {Ls}^{( o )} W \hat{h}\end{matrix} \qquad [ Formula 16 ]$$

However, h (\hat{ }) is a conditional expected value of h given the acoustic feature quantity of the source speaker and the speaker feature quantity, and is expressed by [Formula 17].

$$\begin{matrix}\hat{h} 𝔼 [ h \vert {v}^{( i )} , {s}^{( i )} ] \\ = f ( d + {VLs}^{( i )} + {Ds}^{( i )} + {{W}^{⊤} ( ∘ \frac{1}{3} {Ls}^{( i )} )}^{⊤} \frac{{v}^{( i )}}{{σ}^{2}} )\end{matrix} \qquad [ Formula 17 ]$$

### [3. Voice Conversion/Voice Identity Conversion Operation]

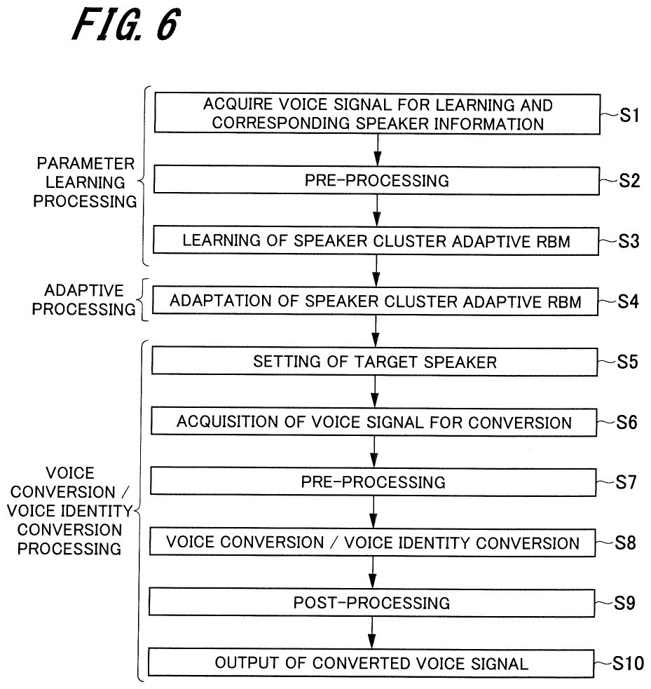

FIG. 6 is a flowchart illustrating voice conversion/voice identity conversion processing according to an exemplary embodiment of the present invention. As illustrated in FIG. 6, as parameter learning processing, the voice signal acquiring part 111 and the speaker information acquiring part 113 of the parameter learning unit 11 of the voice conversion/voice identity conversion device 1 acquires a voice signal for learning and corresponding speaker information respectively based on a user's instruction via the input unit, not illustrated (Step S1).

The preprocessing part 112 generates acoustic information for learning to be supplied to the parameter estimating part 114 from the voice signal for learning acquired by the voice signal acquiring part 111 (Step S2). Here, for example, a voice signal for learning is extracted for each frame (for example, every 5 msec), and a spectral feature quantity (for example, MFCC or mel cepstrum feature quantity) is calculated by applying FFT processing to the extracted voice signal for learning. Then, by performing normalization processing (for example, normalization using average and variance of each dimension) of the calculated spectral feature quantity, acoustic information v for learning is generated.

The generated acoustic information v for learning is output to the parameter estimating part 114 together with the corresponding speaker information s acquired by the speaker information acquiring part 113.

The parameter estimating part 114 performs learning processing of speaker cluster adaptive RBM (Step S3). Here, learning for estimation of various parameters is performed using the speaker cluster c corresponding to the speaker information s for learning and the acoustic information v for learning.

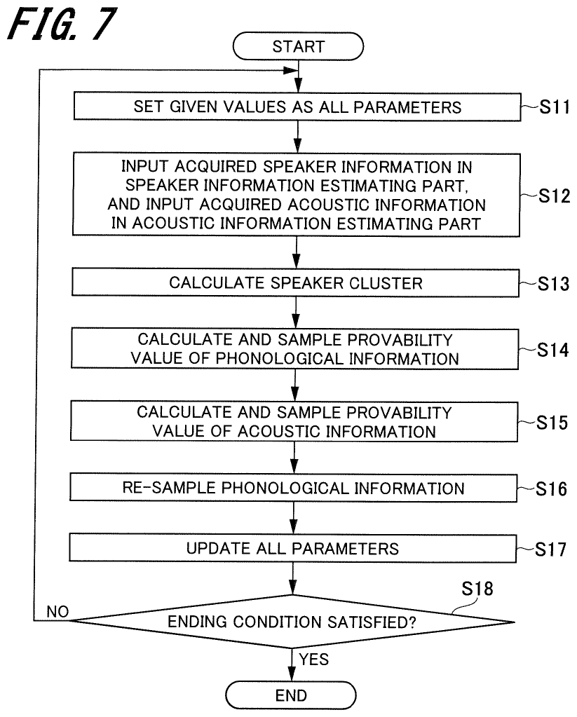

Next, the details of Step S3 will be described with reference to FIG. 7. First, as illustrated in FIG. 7, in the probability model of the speaker cluster adaptive RBM, given values are input to all parameters (Step S11), and the acquired acoustic information v for learning is input to the acoustic information estimating part 1141, and then the acquired corresponding speaker information s is input to the speaker information estimating part 1142 (Step S12).

Then, the speaker cluster calculating part 1144 calculates the speaker cluster c from the corresponding speaker information s acquired by the speaker information estimating part 1142, and the calculated speaker cluster c and the acoustic information v for learning acquired by the acoustic information estimating part 1141 are used as input values (Step S13).

Next, a conditional probability density function of the phonological information h is determined using the speaker cluster c and the acoustic information v for learning input in Step S13, and the phonological information h is sampled based on the probability density function (FIG. Step S14). As used herein the term “to sample” means to randomly generate one piece of data in accordance with the conditional probability density function, and is used in the same meaning hereinafter.

In addition, the conditional probability density function of the acoustic information v is determined using the phonological information h and the speaker cluster c sampled in Step S14, and the acoustic information v for learning is sampled based on the probability density function (Step S15).

Next, the conditional probability density function of the phonological information h is determined using the phonological information h sampled in Step S14 and the acoustic information v for learning sampled in Step S15, and the phonological information h is re-sampled based on the probability density function (Step S16).

Then, the log likelihood L represented by the above-mentioned [Formula 15] is partially differentiated with each parameter, and all parameters are updated by the gradient method (Step S17). Specifically, a stochastic gradient method is used, and expected values for the model can be approximated by using the sampled acoustic information v for learning, the phonological information h, and the corresponding speaker information s.

After updating all the parameters, if the predetermined termination condition is satisfied (YES in Step S18), the process proceeds to the next step, and if not satisfied (NO in Step S18), and the process returns to Step S11 and repeats the subsequent steps (Step S18). Note that, as the predetermined end condition, for example, the number of repetitions of these series of steps may be mentioned.

Referring back to FIG. 6, the description will be continued. The parameter estimating part 114 stores the parameters estimated by the above-described series of steps in the parameter storage unit 13 as parameters determined by learning. Then, based on the input adaptive speaker voice signal, the stored parameters are applied as parameters after adaptation. The parameters after adaptation obtained by this adaptive processing is delivered to the voice quality converting part 124 of the voice conversion/voice identity conversion unit 12 (Step S4).

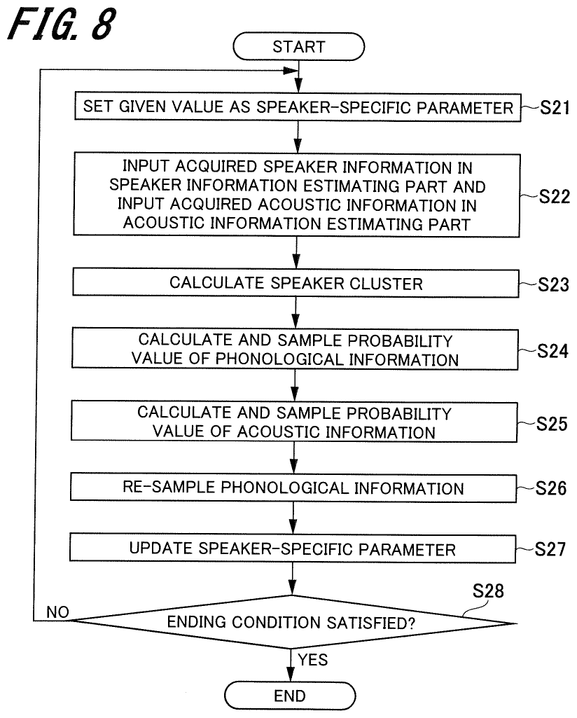

Next, the details of the adaptive processing in Step S4 will be described with reference to FIG. 8. First, as illustrated in FIG. 8, a given value is input as a speaker-specific parameter (Step S21), the acquired adaptive speaker acoustic information v is input to the acoustic information estimating part 1441, and the acquired adaptive speaker information s is input to the speaker information estimating part 1442 (Step S22).

Then, the speaker cluster calculating part 1444 calculates the speaker cluster c from the corresponding speaker information s acquired by the speaker information estimating part 1442, and the calculated speaker cluster c and the acquired acoustic information v of the adaptive speaker are used as input values to the acoustic information estimating part 1441 (Step S23).

Next, a conditional probability density function of the phonological information h is determined using the speaker cluster c and the acoustic information v for the adaptive speaker input in Step S23, and the phonological information h is sampled based on the probability density function (Step S24).

In addition, the conditional probability density function of the acoustic information v is determined using the phonological information h and the speaker cluster c sampled in Step S24, and the acoustic information v of the adaptive speaker is sampled based on the probability density function (Step S25).

Next, the conditional probability density function of the phonological information h is determined using the phonological information h sampled in the Step S24 and the adaptive speaker acoustic information v sampled in the Step S25, and based on the probability density function, the phonological information h is resampled (Step S26).

Then, the log likelihood L represented by the above-mentioned [Formula 15] is partially differentiated with each parameter, and the adaptive speaker-specific parameters are updated by the gradient method (Step S27).

After updating the adaptive speaker-specific parameters, if the predetermined end condition is satisfied (YES in Step S28), the process proceeds to the next step, and if not satisfied (NO in Step S28), the process returns to Step S21, and the respective steps from then onward are repeated (Step S28).

Referring back to FIG. 6, the description will be continued.

As voice conversion/voice identity conversion processing, the user operates an input unit, not illustrated, to set information s(o) of a target speaker as a target of voice conversion/voice identity conversion in the speaker information setting part 123 of the voice quality converting part 12 (Step S5). Then, the voice signal acquiring part 121 acquires a voice signal for conversion (Step S6).

The preprocessing part 122 generates acoustic information based on the voice signal for conversion as in the parameter learning processing, and outputs the acoustic information to the voice quality converting part 124 together with the corresponding speaker information s acquired by the speaker information acquiring part 123 (Step S7).

The voice quality converting part 124 applies speaker cluster adaptive RBM to perform voice conversion/voice identity conversion to convert the voice of the adaptive speaker into the voice of the target speaker (Step S8).

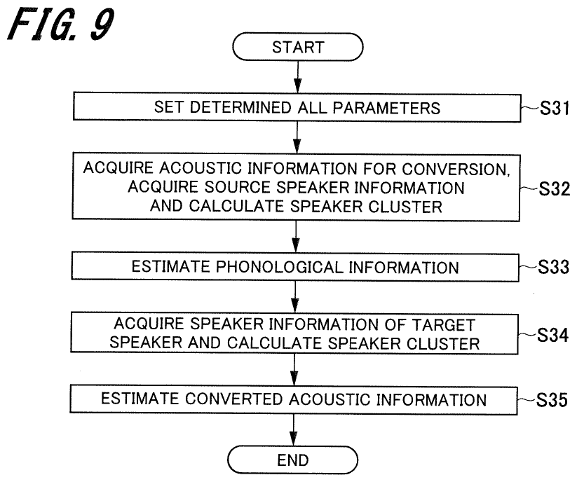

Next, the details of Step S8 will be described with reference to FIG. 9. First, as illustrated in FIG. 9, in the speaker cluster adaptive RBM probability model, all determined parameters are input (Step S31), and then the acoustic information v is input to the acoustic information setting part 1241, the source speaker information s is input to the speaker information setting part 1242, and the speaker cluster calculating part 1244 calculates the speaker cluster c of the source speaker (Step S32).

Then, the phonological information h is estimated using the speaker cluster c and the acoustic information v calculated in Step S32 (Step S33).

Next, the voice quality converting part 124 acquires the speaker information s of the target speaker learned in the parameter learning processing, and the speaker cluster calculating part 1244 calculates the speaker cluster c of the target speaker (Step S34). Then, using the speaker cluster c of the target speaker calculated in Step S34 and the phonological information h estimated in Step S33, the acoustic information setting part 1241 estimates the converted acoustic information v (Step S35). The estimated converted acoustic information v(o) is output to the post-processing part 125.

Referring back to FIG. 6, the description will be continued. The post-processing part 125 generates a converted voice signal using the converted acoustic information v (Step S9). Specifically, denormalization processing (processing to apply the inverse function of the function used for normalization processing described in Step S2) is applied to the normalized converted voice signal v, and the spectral feature quantity subjected to denormalization processing is inversely converted to generate a converted voice signal for each frame. These converted voice signals for each frame are connected in time series to generate a converted voice signal.

The converted voice signal generated by the post-processing part 125 is output to the outside from the voice signal output part 126 (Step S10). By reproducing the converted voice signal with a speaker connected externally, the input voice converted to the voice of the target speaker becomes audible.

### [4. Example of Evaluation Experiment]

Next, in order to demonstrate the effect of the speaker cluster adaptive RBM according to the present invention, an example in which voice conversion/voice identity conversion experiments are performed will be described.

For the learning of the probability model, R=8; 16; 58 speakers were randomly selected from the continuous voice database (ASJ-JIPDEC) for research in the Acoustical Society of Japan, and 40 sentences of voice data were used. For evaluation of the learning speaker, one male (ECL0001) was set as a source speaker, one female (ECL1003) was set as a target speaker, and voice data of 10 sentences different from the learning data was used. In the adaptation of the probability model, female speakers (ECL1004) and male speakers (ECL0002) not included in learning are source speakers and target speakers, respectively, and the number of sentences of adaptation data was changed from 0.2 to 40 for evaluation. Also for the evaluation of the adaptive speaker, voice data of 10 sentences not included in the adaptive data was used. A 32-dimensional mel cepstrum calculated from the spectrum obtained by the analysis and synthesis tool (WORLD: URL http://ml.cs.yamanashi.ac.jp/world/index.html) was used as the input feature quantity (I=32). In addition, the numbers of potential phonological feature quantities were set to J=8; 16; 24, and the numbers of clusters were set to K=2; 3; 4; 6; 8, and the numbers providing the highest accuracy were employed. The probability model was trained using a stochastic gradient method with a learning rate of 0:01, a moment coefficient of 0:9, a batch size of 100×R, and the number of times of repetition of 100.

As an index for measuring the accuracy of voice conversion/voice identity conversion, an average value of MDIR (mel-cepstral distortion improvement ratio) defined by the following [Formula 18] was used.

$$MDIR [ dB ] = \frac{10 \sqrt{2}}{ln 10} ( {‖ {v}_{o} - {v}_{i} ‖}_{2} - {‖ {v}_{o} - {\hat{v}}_{o} ‖}_{2} ) \qquad [ Formula 18 ]$$

Here, vₒ, vᵢ, vₒ (\hat{ }) represents the mel cepstrum feature quantities of the target speaker's speech in alignment with the source speaker, and the mel cepstrum feature quantity of the source speaker's voice in the same alignment, and the mel cepstrum feature quantities of voice obtained by applying voice conversion/voice identity conversion to vᵢ, respectively. MDIR represents the improvement rate, and the larger the value, the higher the conversion accuracy.

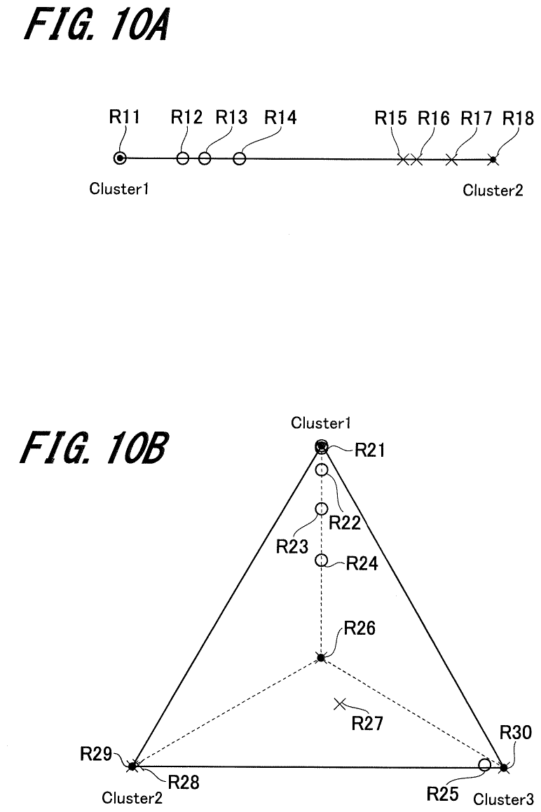

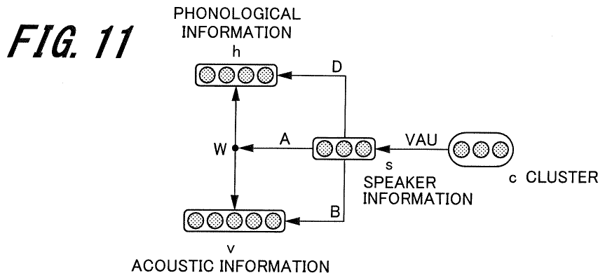

First, distributions of cluster weights λᵣ of the respective estimated speakers when K=2; R=8 and K=3; R=16 are illustrated in FIGS. 10A and 10B. In the example of FIG. 10A, K=2, and two clusters of a male cluster (Cluster 1) and a female cluster (Cluster 2) are automatically formed. In the example of FIG. 10B, K=3, and in addition to the male cluster (Cluster 1) and the female cluster (Cluster 2), another cluster (Cluster 3) in which men and women are further mixed is automatically formed. In FIGS. 10A and 10B, the positions R11 to R18 and R21 to R30 of the speaker cluster of each learner are illustrated, and the voices indicated by circles are male voices, and the voices indicated by crosses are female voices.

As can be seen from FIGS. 10A and 10B, male voices indicated by circles are at positions close to (Cluster 1) (cluster weight), and female voices indicated by crosses are learned at positions near (Cluster 2). Therefore, it can be seen that male clusters (Cluster 1) and female clusters (Cluster 2) are formed automatically even though gender teachers are not given. As illustrated also in FIGS. 10A and 10B, in the learning data, two clusters are learned to be the most apart. In other words, the speaker pairs which are the most distant from each other are set at positions overlapping on their respective clusters (Cluster 1 and Cluster 2). The position of the weight to the speaker cluster is then set among a plurality of clusters learned so that the respective clusters are learned to be are located at positions farthest from each other. The property of learning so that the plurality of clusters are located at the positions farthest from each other is preferable because the adjustable range is increased when converting into a given voice by adjusting points of dividing the respective clusters (representative speaker) freely.

Next, an example of comparing the conversion accuracy of the learning speaker of the probability model (illustrated as CAB) by the speaker cluster adaptive RBM according to the present invention and the adaptive RBM (illustrated as ARBM) which is the non-parallel voice conversion/voice identity conversion method of the related art is illustrated in [Table 1]. Here, an example in which the numbers of learning persons are 8, 16, and 58 is illustrated, and illustrates that the higher the value, the higher the accuracy.

TABLE 1

| # persons | 8 | 16 | 58 |
|---|---|---|---|
| ARBM | 3.70 | 2.64 | 3.02 |
| CAB | 3.21 | 3.06 | 3.23 |

The adaptive RBM (ARBM) of the related art illustrates to have high accuracy when the number of speakers is small, but it can be seen that the accuracy decreases when the number of speakers is increased. On the other hand, in a speaker cluster adaptive RBM probability model (CAB) in which the number of parameters for each speaker is reduced, there is not much change in accuracy even if the number of speakers is increased.

[Table 2] is an example comparing the conversion accuracy according to the number of sentences between the probability model with the speaker cluster adaptive RBM according to the present invention and the probability model with the adaptive RBM (ARBM) of the related art.

TABLE 2

| # sent. | 0.2 | 0.5 | 1 | 10 | 40 |
|---|---|---|---|---|---|
| ARBM | 2.48 | 3.25 | 3.21 | 3.41 | 3.45 |
| CAB | 3.14 | 3.54 | 3.63 | 3.60 | 3.58 |

As apparent from [Table 2], when the number of sentences used for adaptation is 1 or less, the accuracy is reduced in the model of the related art, but in the speaker cluster adaptive RBM probability model (CAB), it is about 0.5 sentences, which provides the same performance as in the case of 10 or more sentences.

As described above, according to the present invention, the speaker cluster is acquired from the speaker information, and the probability model is obtained using the speaker cluster, so that the quality of the source speaker's voice can be converted into the target speaker voice with a significantly small number of data as compared to the related art.

### [5. Modification]

In the exemplary embodiment described so far, as processing for obtaining the acoustic information v and the phonological information n of the target speaker, the acoustic information v and the phonological information n of the target speaker are obtained from the parameters A, V and U that are possessed by speaker cluster c as illustrated in the graph structure of the speaker cluster adaptive RBM of FIG. 5.

On the other hand, as illustrated in FIG. 11, it is also possible to obtain the speaker information s of the target speaker from the parameters A, V and U possessed by the speaker cluster c, then use the obtained speaker information s to obtain the speaker-dependent parameters D, A, and B, and obtain the acoustic information v and the phonological information n of the target speaker from these parameters D, A, and B. For the processing of obtaining the acoustic information v and the phonological information n of the target speaker from the speaker-dependent parameters D, A, and B, for example, the process described in the graph structure of adaptive RBM in FIG. 4 is applicable.

As illustrated in FIG. 11, it is also possible to obtain the acoustic information v and the phonological information n of the appropriate target speaker in the same manner as in the example illustrated in FIG. 5, by obtaining the speaker information s of the target speaker by using the speaker cluster c and then obtaining the acoustic information v and the phonological information n of the target speaker. When the process illustrated in FIG. 11 is performed, the acoustic information v and the phonological information n of the target speaker are obtained from the speaker information s of the target speaker, so that the accuracy of each information is improved. However, the amount of data increases more than in the example of FIG. 5.

In the exemplary embodiment described thus far, after learning processing of parameters for voice conversion/voice identity conversion has been performed by learning with a voice signal for learning, the parameter is adapted to the adaptive speaker voice signal by the input of the adaptive speaker voice signal, and then the voice conversion/voice identity conversion is applied to the voice signal of the target speaker using the adapted parameters. In this configuration, the voice quality of the voice signal (adaptive speaker voice signal) which is not learned in advance can be converted into the voice signal of the target speaker. In contrast, it is also possible to omit the input of the adaptive speaker voice signal, and convert the voice quality of the learning speech into the voice signal of the target speaker by using the parameters obtained by the voice signal for learning.

In this case, in the voice conversion/voice identity conversion device 1, the parameter storage unit 13 may store parameters obtained by learning in the parameter learning unit 11 as the configuration illustrated in FIG. 1, for example, and the voice conversion/voice identity conversion processing unit 12 may apply the parameters stored in the parameter storage unit 13 to perform conversion processing of the input voice to the voice of the target speaker.

Also, in the exemplary embodiment described so far, the example of processing the voice of human's speech as the input voice for learning (the voice of the source speaker) and the input voice for adaptation has been described. However, if learning to obtain each piece of information described in the exemplary embodiment is possible, various sounds other than human speech may be used as voice signals (input signals) for learning and adaptation, and the voice signals may be learned or adapted. For example, sounds such as siren sounds or animal calls may be learned or adapted.

### REFERENCE SIGNS LIST

1 voice conversion/voice identity conversion device
11 parameter learning unit
12 voice conversion/voice identity conversion processing unit
13 parameter storage unit
14 adaptive unit
101 CPU
102 ROM
103 RAM
104 HDD/SDD
105 connection I/F
106 communication I/F
111, 121, 141 voice signal acquiring part
112, 122, 142 pre-processing part
113 corresponding speaker information acquiring part
114, 144 parameter estimating part
1141, 1441 acoustic information estimating part
1142, 1442 speaker information estimating part
1143, 1443 phonological information estimating part
1144, 1444 speaker cluster calculating part
123 speaker information setting part
124 voice quality converting part
1241 acoustic information setting part
1242 speaker information setting part
1243 phonological information setting part
1244 speaker cluster calculating part
125 post-processing part
125 voice signal output part

1. A voice conversion/voice identity conversion device that converts a voice of a source speaker into a voice of a target speaker, comprising:
a parameter learning unit that determines a parameter for voice conversion/voice identity conversion from acoustic information based on a voice for learning and speaker information corresponding to the acoustic information;
a parameter storage unit that stores a parameter determined by the parameter learning unit; and
a voice conversion/voice identity conversion processing unit that performs voice conversion/voice identity conversion processing of the acoustic information based on the voice of the source speaker based on the parameter stored in the parameter storage unit and the speaker information of the target speaker, wherein
the parameter learning unit uses the acoustic information based on the voice, the speaker information corresponding to the acoustic information, and phonological information representing a phoneme in the voice as variables, so that a probability model representing a relationship in connection energy among the acoustic information, the speaker information and the phonological information by the parameter is obtained and a plurality of speaker clusters having specific adaptive matrices are defined as the probability model.

2. The voice conversion/voice identity conversion device according to claim 1, further comprising an adaptive unit that adapts the parameter stored in the parameter storage unit to the voice of the source speaker to obtain a parameter after the adaptation, wherein
the parameter storage unit stores the parameter after the adaptation by the adaptive unit, and the voice conversion/voice identity conversion processing unit performs voice conversion/voice identity conversion processing of the acoustic information based on the voice of the source speaker based on the parameter after the adaptation and the speaker information of the target speaker.

3. The voice conversion/voice identity conversion device according to claim 2, wherein
the parameter learning unit and the adaptive unit are configured by a common arithmetic processing part, and
the common arithmetic processing part is configured to perform a process of determining the parameter based on the voice for learning and a process of obtaining the parameter after the adaptation based on the voice of the source speaker.

4. The voice conversion/voice identity conversion device according to claim 1, wherein
when the parameter learning unit performs learning, the parameter learning unit learns so that the plurality of clusters are located at positions farthest from each other, and sets a position of a weight to the speaker cluster among the plurality of learned clusters.

5. The voice conversion/voice identity conversion device according to claim 1, wherein
the voice conversion/voice identity conversion processing unit obtains speaker information of the target speaker from the parameter, and obtains acoustic information of the target speaker from the obtained speaker information.

6. The voice conversion/voice identity conversion device according to claim 1, wherein assuming that a two-way connection weight W∈R^{I×J} depending on a feature quantity s=[s₁, . . . , s_{R}]∈{0,1}^{R}, Σᵣsᵣ=1 of the speaker information exists between a feature quantity v=[v₁, . . . , v_{I}]∈R^{I} of the acoustic information and a feature quantity h=[h₁, . . . , h_{J}]∈{0,1}^{J}, Σⱼhⱼ=1 of the phonological information, a speaker cluster c∈R^{K} is introduced as the speaker cluster, and a speaker cluster c is expressed as
c [symbol] Ls′
(where, each column vector λᵣ of L∈^{K×R}=[λ₁ . . . λ_{R}] is a non-negative parameter representing a weight to each speaker cluster, and a constraint of ∥λᵣ∥₁=1, ∀ᵣ is imposed), and each of a speaker-independent term, a cluster dependent term, and a speaker-dependent term is expressed as
w [symbol] [symbol] ·⅓cW
\tilde{b} [symbol] b+Uc+Bs
\tilde{d} [symbol] d+Vc+Ds
where a bias parameter of a cluster-dependent term of a feature quantity of acoustic information is U∈R^{I×K}, and a bias parameter of the cluster-dependent term of a feature quantity of the phonological information is V∈R^{J×K}.

7. A voice conversion/voice identity conversion method for converting a quality of a voice of a source speaker to a voice of a target speaker, comprising:
a parameter learning step including: using acoustic information based on the voice, speaker information corresponding to the acoustic information, and phonological information representing a phoneme of the voice as variables to prepare a probability model representing a relationship in connection energy among the acoustic information, the speaker information, and the phonological information by a parameter; defining a plurality of speaker clusters having specific adaptive matrices as the probability model; estimating a weight to the plurality of speaker clusters for respective speakers; and determining the parameter of the voice for learning; and
a voice conversion/voice identity conversion processing step of performing, based on a parameter obtained in the parameter learning step or a parameter after adaptation obtained by adapting the parameter to a voice of the source speaker and the speaker information of the target speaker, voice conversion/voice identity conversion processing of the acoustic information based on the voice of the source speaker.

8. A program that causes a computer to execute:
a parameter learning step including: using acoustic information based on the voice, speaker information corresponding to the acoustic information, and phonological information representing a phoneme of the voice as variables to prepare a probability model representing a relationship in connection energy among the acoustic information, the speaker information, and the phonological information by a parameter; defining a plurality of speaker clusters having specific adaptive matrices as the probability model; estimating a weight to the plurality of speaker clusters for respective speakers; and determining and storing the parameter of the voice for learning; and
a voice conversion/voice identity conversion processing step of performing, based on a parameter obtained in the parameter learning step or a parameter after adaptation obtained by adapting the parameter to a voice of the source speaker and the speaker information of the target speaker, voice conversion/voice identity conversion processing of the acoustic information based on the voice of the source speaker.
